(19) United States
(12) Patent Application Publication
(10) Pub. No.: US 2001/0038067 A1
(43) Pub. Date: Nov. 8, 2001

(54) Illuminated article-locator

(76) Inventor: Susan Henoch, Corrales, NM (US)

Correspondence Address: DARBY & DARBY P.C., 805 Third Avenue, New York, NY, 10022, US

(21) Appl. No.: 09/848,526

(22) Filed: May 3, 2001

Related U.S. Application Data
(60) Provisional application No. 60/201,982, filed on May 3, 2000.

(51) Int. Cl. H01J 40/14

(52) U.S. Cl. 250/221

(57) ABSTRACT

An illumination device includes a waveguide body, a source of illumination, a triggering mechanism, a battery, a connecting ring, and controlling circuitry. The device is attached to an article (such as a set of keys) using the connecting ring. The source of illumination includes at least one light emitting diode (LED) whose output is in optical communication with the waveguide body so that when lit, the LED's output illumination is transmitted throughout the waveguide body. Power to the LED(s) is supplied by the battery and is controlled by the controlling circuitry and the triggering mechanism. The triggering mechanism includes a motion or movement detector, preferably based on an electro-mechanical spring-switch. A method for using the device includes attaching the device to an article, such as a set of keys and shaking the keys (directly or indirectly) to cause the triggering mechanism to signal the controlling circuitry, which in turn, activates at least one LED. The light from the LED transmits throughout the waveguide body creating an even, soft glow-like illumination through the entire body thereby illuminating the relatively large waveguide body of the device.

### BACKGROUND OF THE INVENTION

a) Field of the Invention

This invention generally relates to illuminated devices, and more particularly, to such devices that may be attached to articles and used to help reveal their location within an environment.

b) Description of the Prior Art

In this complex world, it is not uncommon to misplace any of a variety of articles we tend to use each day, such as keys, eyeglasses, cell phones and wallets. We often misplace these articles because we put them down at a particular location, become distracted, and then leave the area probably thinking about something else. These items are rarely actually lost, just misplaced and their owner typically won't realize that an item is missing until, of course, they need to use it.

To overcome this problem and to help people keep track of their everyday belongings, a variety of devices have been developed, many of which are based on radio frequency transponder technology. These prior art locating devices usually include a transponder and a transmitter. The user would attach the transponder to an article that he or she wishes to keep track of (prior to it being lost of course). Should the item become misplaced, the owner simple activates the transmitter so that a radio frequency signal is transmitted within a prescribed area. If the transponder (and, therefore, the attached item) is within that area, the RF signal will cause the transponder to “respond”, usually audibly, such as a beeping sound, but may also include an appropriate illumination source as well.

These prior art item-locating devices are unnecessarily complex and require that the user carry the transmitter portion, which is yet another small item to keep track of and which will probably just get lost, anyway. Also, these RF item-locating devices of the prior art are only useful at finding items that have been misplaced in a relatively open and spacious environment, such as on a desk or in a car. These devices fail to help locate an item that is among many other items in a relatively closed and small environment, such as finding a set of keys in a purse filled with other items.

Applicant has recognized the need to provide a simple illumination device that may be attached to an item so that upon the activation of the device, the item may be easily found.

### SUMMARY OF THE INVENTION

An illumination device includes a waveguide body, a source of illumination, a triggering mechanism, a battery, a connecting ring, and controlling circuitry. The device is preferably attached to an article (such as a set of keys) using the connecting ring. The source of illumination includes at least one light emitting diode (LED) whose output is in optical communication with the waveguide body so that when lit, the LED's output illumination is transmitted throughout the waveguide body. Power to the LED(s) is supplied from the battery, as controlled by the controlling circuitry and the triggering mechanism. The triggering mechanism includes a motion or movement detector, preferably based on an electromechanical spring-switch. This type of switch sends a triggering signal to the controlling circuitry when movement of the device is sufficient to displace the spring portion of the triggering mechanism into contact with an electrical terminal.

A method for using the device includes attaching the device to an article, such as a set of keys and shaking the keys (directly or indirectly) to cause the triggering mechanism to signal the controlling circuitry, which in turn, activates at least one LED. The light from the LED transmits throughout the waveguide body creating an even, soft glow-like illumination through the entire body thereby illuminating the relatively large waveguide body of the device.

### BRIEF DESCRIPTION OF THE DRAWINGS

FIG. 1 is an assembly view of an illumination device, according to the invention;

FIG. 2 is a perspective view of the illumination device, according to the invention;

FIG. 3 is a sectional view of the illumination device, taken along the lines 3-3 of FIG. 2, showing details of the illumination module, according to the invention;

FIG. 4 is a sectional view of the illumination device, taken along the lines 4-4 of FIG. 3, showing details of the illumination module, according to the invention; and

FIG. 5 is an illustrative schematic of the operation of the illumination module and LED controlling circuitry, according to the invention.

### DETAILED DESCRIPTION OF THE PREFERRED EMBODIMENT

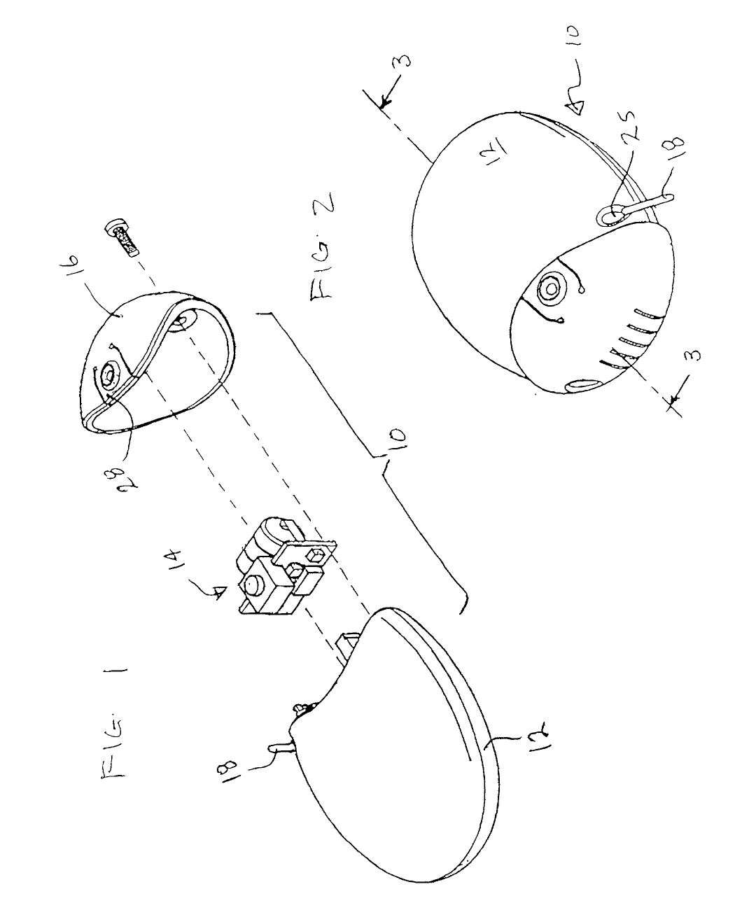

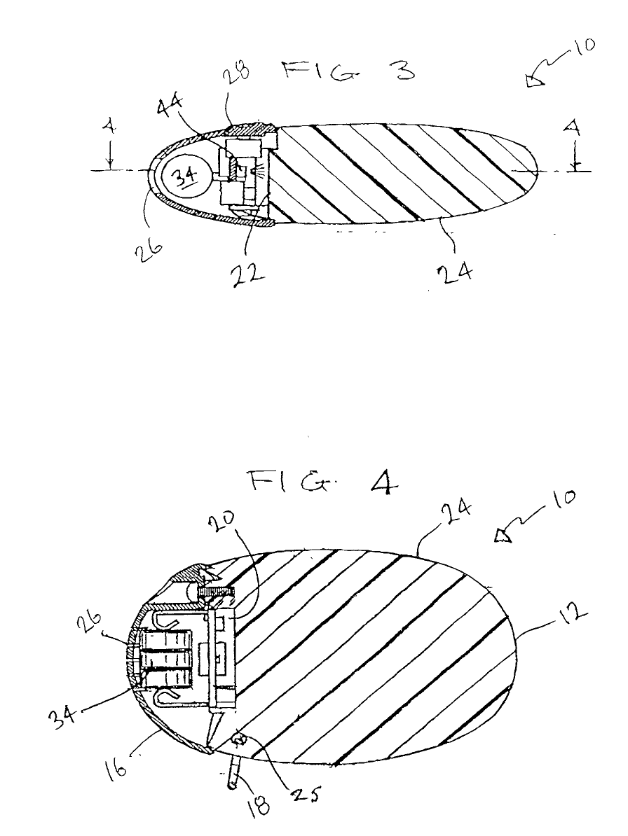

Referring to FIG. 1, an illumination device 10, according to the invention is shown, including a waveguide body 12, an illumination module 14, a cap 16, and a connecting ring 18. Waveguide body 12 is preferably ellipsoidal in shape (similar to the shape of a slightly flattened egg with smooth rounded edges) and includes a module-receiving recess 20 defining a generally flat light receiving surface 22, located at one end, and further includes a outer diffusing surface 24 (such as a frosted surface). Surface 22 can include a hemispherical or semi-ellipsoidal-shaped recess to receive light from illumination module 14. Of course, waveguide body 12 can take on any suitable shape without departing from the invention. Waveguide body 12 is preferably made from an optical-grade plastic, such as Acrylic, or a plastic that can function, at least to some extent, as an optical waveguide, i.e., it is capable of transmitting light that is projected at light-receiving surface 22 throughout the body to the frosted surface 24.

Waveguide body 12 is preferably molded as a single unit, however, the body may alternatively be molded as two halves and secured together. Also, the waveguide body 12 may be molded around illumination module 14, thereby encasing the operating circuitry and batteries used to illuminate device 10. This also ensures that device 10 will endure a variety of environmental conditions that are typically hazardous to electronic components. These may include water (liquid or moisture), dust, insects, impact (such as if the device is dropped), and unintentional prying forces, such as from other objects.

Connecting ring 18 is secured to waveguide body 12, through an opening 25, and may be used to secure device 10 to an article (not shown), such as a set of keys.

Module-receiving recess 20 is sized and shaped to snugly receive illumination module 14, which may be secured therein using any appropriate means including mechanical screw fasteners, snap-arrows, clips, or even an appropriate adhesive. As described below, cap 16 is secured to waveguide body 12, covering the illumination module 14. Cap 16 may include vents 26 to help cool the illumination module 14, and an integrally formed pivotal switch-contacting tab 28. Tab 28 aligns with a switch of the illumination module 14, as described below. Cap 16 is preferably shaped to compliment the shape of the waveguide body 12 so that the body 12 and the cap 16 together form a desired uniform and continuous shape, such as an ellipsoidal shape.

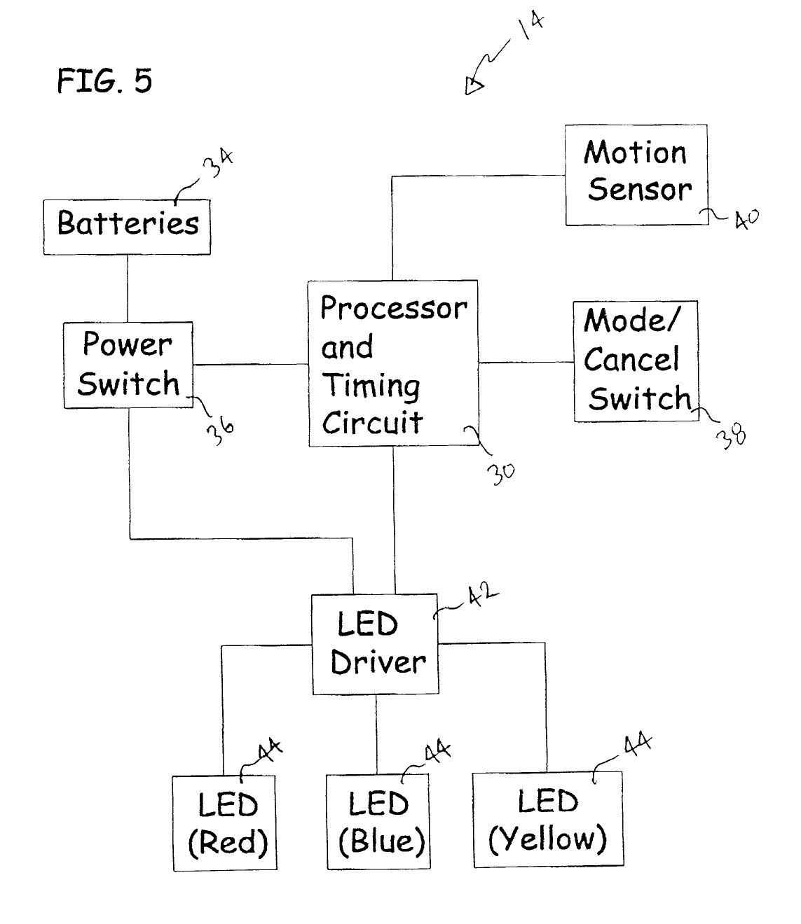

Referring to FIGS. 1 and 5, light illumination module 14 includes a processor 30, (which preferably includes a timing circuit and an electronic memory for storing operating instructions), a power supply 34, such as batteries, a power switch 36 (optional), a mode/cancel switch 38, a motion/movement switch 40, an LED-driver circuit 42, and at least one light emitting diode (LED) 44. Three LEDs are preferably used, the light output of each being a different color (a single LED with multiple colored outputs may also be used). All of the above-described components of the illumination module 14 are preferably all commonly secured to a circuit board 46. Appropriate use of semiconductor components and/or surface mounted devices may be utilized to make the light-illumination module 14 power-efficient and as small as possible, as understood by those skilled in the art.

Power supply 34 provides the electrical power requirements for processor 30, LED driver circuit 42, and LEDs 44. If power switch 36 is used, it would selectively connect power supply 34 to processor 30 and LED driver 42 (which would, in turn, power each LED, as necessary). Since the illumination module 14 is sensitive to motion, as described below, power switch 36 is not necessary, since no LED will illuminate unless the device 10 is moved in a jarring manner, sufficient to trigger motion/movement switch 40, and the device will therefore conserve power until it is used.

As is understood by those skilled in the art of electronics, LED driver circuit 42 is used to power up each of several connected LEDs, as instructed by processor 30. Processor 30 inputs signals from motion/movement switch 40, and mode/cancel switch 38. If the device is moved quickly enough, the motion/movement switch 40 (which is essentially a spring switch) will effectively send a “trigger” signal to processor 30, which will in turn, instruct LED driver circuit 42 to illuminate at least one LED 44, according to a preset sequence code (software). A timing circuit is preferably included within processor 30 to control the length of time that any LED illuminates, once triggered to do so (such as 10 seconds). Mode/cancel switch is connected to processor 30 and is used to turn off any illuminating LED prior to completion of its activation time (e.g., 10 seconds). When device 10 is completely assembled, cap 16 is mounted or secured to body 12 so that tab 28 aligns with mode/cancel switch 38. This allows for manual activation of switch 38 from outside of device 10.

Mode/cancel switch 3 8 may also be used to select illumination characteristics, such as how each LED illuminates, their respective duration and color, and sequence. For example, three LEDs may be used, each emitting a different color, e.g., red, yellow, and blue. Processor 30 may be used to allow the red LED to flash at a first rate, the yellow LED at a second rate, and the blue LED perhaps to illuminate continuously, for 10 seconds. In another “mode”, for example, processor 30 would alternate illumination of each LED 44, from one color to the next, allowing a slow transition from one color to the next. Many other sequences and illumination effects can be programmed into the processor 30 and selected by the user (or may alternate automatically).

Regardless, when lit, the light from the LED transmits throughout the waveguide body creating an even, soft glow-like illumination through the entire body thereby illuminating a major portion of device 10. The intensity of the resulting glow-like illumination may be designed according to the particular application of the device. In most applications, the device is to be used in darker environments, such as within a container (pocket book, bag, briefcase, etc.), but of course, may be adjusted so that the illumination can be seen in brighter ambient conditions.

In use, the device 10 is intended to be secured to any item or article that the user would like to quickly find in a dark enclosing environment. Device 10 is particularly useful when secured to an article that is typically stored within a carrying bag, large pocket-book, briefcase, pocket, or a backpack, such as a set of car keys, for example. Typically, there are many different items held in such carriers that it is often difficult to find any one item. By attaching the present device 10 to an item of high use and importance (e.g., car keys), the user merely has to shake their carrier (such as their briefcase or pocket book) to cause motion/movement sensor 38 to cause processor 30 to instruct at least one LED 44 to illuminate the entire waveguide body 12, thereby quickly revealing its location (along with its attached item) within the carrier among the other items.

Applicant also contemplates the use of illumination device 10 as something to wear, as a form of jewelry. In this application, waveguide body 12 would be shaped in decorative and lightweight forms so that they may be attached to decorative chains, earrings, rings, broaches, pins, (including pierced jewelry), and hair-supported clips and devices. The illumination device 10, in this application, would illuminate in response to movement of the wearer of the jewelry.

Applicant further contemplates incorporating light illuminating module 14 within a battery pack of a cellular telephone (not shown) so that if the user shakes the phone (directly or indirectly) at least one LED will illuminate so that the location of the phone is revealed. With this application, the LEDs and controlling circuitry can be powered by the battery of the cellular telephone. If the phone is in use, the LED circuitry can be deactivated.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto. All patents, patent applications, procedures, and publications cited throughout this application are hereby incorporated by reference in their entireties.

What is claimed is:

1. An illumination device to be affixed to an article, said illumination device comprising:
a translucent body, said body forming a majority portion of said device;
at least one LED located adjacent to said body;
a movement sensor affixed to said body, said movement sensor generating a trigger signal in response to a predetermined magnitude of acceleration applied to said body;
a controller for controlling the illumination of said LED, said controller activating in response to said movement sensor generating said trigger signal, said illumination of said LED being directed through said translucent body; and
a fastener connected to said body, said fastener allowing mechanical securement between said device and said article.

2. The illumination device, according to claim 1, wherein said translucent body is formed as a single-piece of material and said LED, said movement sensor, and said controller are call connected to a common substrate, defining an illumination module.

3. The illumination device, according to claim 2, wherein said illumination module is positioned within said single-piece translucent body.

4. The illumination device, according to claim 1, wherein said at least one LED includes three LEDs, each emitting a different color light into said body.

5. The illumination device, according to claim 4, wherein said LED controller includes a processor, a LED driver circuit, and a timing circuit.

6. The illumination device according to claim 1, wherein said translucent body is made from Acrylic and has an outer surface, a portion of said outer surface having a matte frosted texture.

7. The illumination device according to claim 5, wherein said LED driver controls the illumination of each of said three LEDs following one of several instruction sets stored in memory in said processor.

8. The illumination device according to claim 1, wherein said movement sensor includes a mechanical spring switch.

9. The illumination device according to claim 1, wherein said movement sensor includes a mercury-type switch.

10. The illumination device according to claim 1, wherein said movement sensor includes an accelerometer-type sensor used to measure the acceleration of the device.

11. An illumination device to be affixed to an article or a person, said illumination device comprising:
a translucent body, said body forming a majority portion of said device;
at least one LED located adjacent to said body;
a movement sensor affixed to said body, said movement sensor generating a trigger signal in response to a predetermined magnitude of acceleration applied to said body;
a controller for controlling the illumination of said LED, said controller activating in response to said movement sensor generating said trigger signal, said illumination of said LED being directed through said translucent body.

12. The illumination device, according to claim 11, wherein said translucent body is formed as a single-piece of material and said LED, said movement sensor, and said controller are all connected to a common substrate, defining an illumination module.

13. The illumination device, according to claim 12, wherein said illumination module is positioned within said single-piece translucent body, and said body is wearable as jewelry.

14. A method for finding a particular item among several items within a relatively dark environment, the steps comprising:
attaching an illumination device to said particular item, said illumination device including a translucent body, a source of illumination directed through said body, and a movement detector for activating said source of illumination in response to a predetermined magnitude of movement; and
moving said items within said environment sufficiently to cause said movement detector to activate said source of illumination so that said resulting illumination through said body reveals the location of said attached particular item within said environment.

15. An illumination device to be affixed to an article, said illumination device comprising:
a translucent body, said body forming a majority portion of said device;
at least one LED located adjacent to said body;
a movement sensor affixed to said body, said movement sensor generating a trigger signal in response to a predetermined magnitude of acceleration applied to said body;
a controller for controlling the illumination of said LED, said controller activating in response to said movement sensor generating said trigger signal, said illumination of said LED being directed through said translucent body; and
a fastener connected to said body, said fastener allowing mechanical securement between said device and said article.
